(19) United States
(12) Patent Application Publication
(10) Pub. No.: US 2016/0232606 A1
(43) Pub. Date: Aug. 11, 2016

(54) Systems and Methods for Use in Providing Lending Products to Consumers

(71) Applicant: MASTERCARD INTERNATIONAL INCORPORATED, Purchase, NY (US)

(72) Inventor: Rohit Chauhan, Somers, NY (US)

(21) Appl. No.: 14/619,800

(22) Filed: Feb. 11, 2015

(51) Int. Cl. G06Q 40/02

(52) U.S. Cl. CPC G06Q 40/025

(57) ABSTRACT

Systems and methods are directed toward providing lending products to consumers, whose credit records are limited or nonexistent (e.g., unbanked consumers, underbanked consumers, etc.), based on purchasing behaviors of the consumers (with or without separate credit evaluation). In connection with providing the lending products, purchase data is initially received from a merchant for products purchased from the merchant by the consumers. Profiles are then compiled for the consumers, based on the purchase data, and correlated to a metric profile to determine whether or not to qualify the consumers to one or more appropriate lending products.

### FIELD

The present disclosure generally relates to systems and methods for use in providing lending products to consumers based on purchasing behaviors of the consumers.

### BACKGROUND

This section provides background information related to the present disclosure which is not necessarily prior art.

Lending products (e.g., credit cards, lines of credit, loans, etc.) are often provided to consumers for use in purchasing goods and/or services from merchants. Typically, decisions to provide the lending products to the consumers are based on credit records of the consumers, generated from prior borrowing and repaying records of the consumers (e.g., using prior credit data for the consumers, etc.). The credit records represent the consumers' credit worthiness and, generally, whether or not the consumers pose risks to repaying money to issuers of the lending products. Separately, merchants are known to offer loyalty programs, which track purchases of consumers, and often provide rewards for certain transaction thresholds.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in providing lending products to consumers based on purchasing behaviors of the consumers;

FIG. 2 is a block diagram of an exemplary computing device that may be used in the system of FIG. 1;

FIG. 3 is an exemplary method, suitable for use with the system of FIG. 1, for providing the lending products, in particular, to certain consumers (e.g., unbanked consumers, underbanked consumers, etc.); and

FIG. 4 is a block diagram of exemplary profiles of consumers, compiled from purchase data for the consumers, that can be used in connection with providing the lending products to the consumers in the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Lending products (e.g., credit cards, lines of credit, loans, etc.) are often provided to consumers based on the their credit records (e.g., credit files, credit histories, etc. generated for the consumers based on prior credit data of the consumers). However, many consumers (e.g., unbanked consumers, underbanked consumers, etc.) lack sufficient credit records for issuers to justify providing them with such lending products due to, for example, lack of activity or delinquency. Systems and methods herein leverage data other than credit data to generate (and justify) lending product decisions for consumers (e.g., to provide indications of credit worthiness for the consumers and levels of credit to make available, etc.). As such, in some implementations, the systems and methods can be used to provide unbanked consumers and/or underbanked consumers and/or other consumers lending products that, normally, would not be available to them because of their insufficient or lacking credit records.

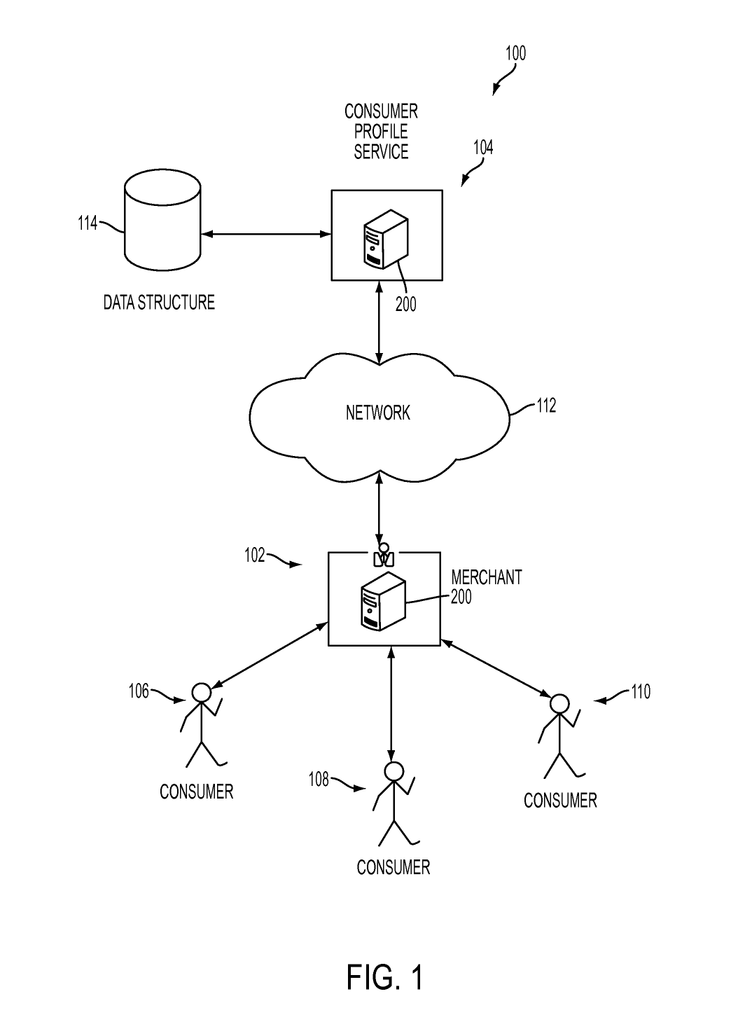

With reference now to the drawings, FIG. 1 illustrates an exemplary system 100, in which one or more aspects of the present disclosure may be implemented. The system 100 is suitable for use in providing lending products to consumers based on purchasing behaviors of the consumers (and in lieu of separate credit evaluations and/or credit data typically used, or in addition thereto). Although the components of the system 100 are presented in one arrangement, it should be appreciated that other exemplary embodiments may include the same or different components arranged otherwise, for example, depending on associations between the various components/entities of the system 100, manners of compiling and/or communicating data, etc.

As shown in FIG. 1, the illustrated system 100 generally includes a merchant 102 and a consumer profile service 104. As will be described, consumers 106-110 interact with the merchant 102 in the system 100 to purchase products and services (in person, online, etc.). The consumer profile service 104 then uses purchase data generated by these interactions to qualify select ones of the consumers 106-110 (e.g., target consumers, consumers with little or no credit records (e.g., unbanked consumers, underbanked consumers, etc.), etc.) for lending products. The consumer profile service 104 may be a separate entity, as shown in FIG. 1, or it may be associated with other entities not shown in FIG. 1 (e.g., a payment network configured to facilitate payment transactions in the system 100, an issuer of payment accounts to the consumers 106-110 in the system 100, etc.).

In the illustrated system 100, each of the merchant 102 and the consumer profile service 104 are coupled to network 112. In some embodiments, one or more of the consumers 106-110 may also be coupled to the network 112, as desired. The network 112 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 112 includes multiple networks, where different ones of the multiple networks are accessible to different ones of the illustrated components in FIG. 1.

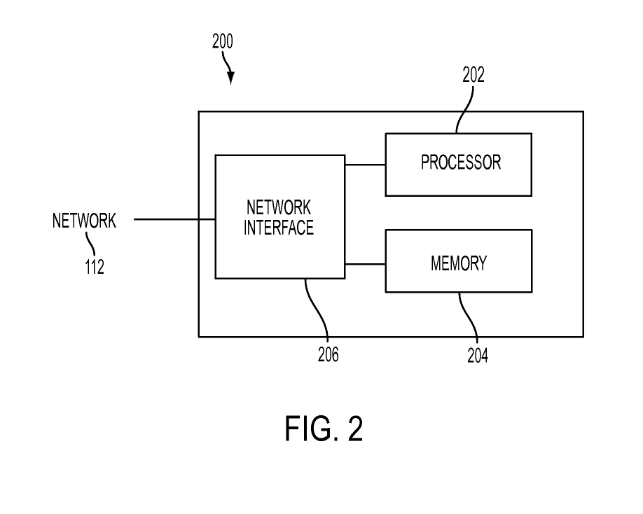

In addition, each of the merchant 102 and the consumer profile service 104 of the system 100 may be implemented in one or more computing devices. In some embodiments, one or more of the consumers 106-110 may also be implemented in one or more computing devices. For illustration, the merchant 102 and the consumer profile service 104 are illustrated in FIG. 1 and described herein with reference to exemplary computing device 200, illustrated in FIG. 2. However, the system 100 and its components should not be considered to be limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region. Additionally, in some embodiments, each computing device 200 may be coupled to a network (e.g., the Internet, an intranet, a private or public LAN, WAN, mobile network, telecommunication networks, combinations thereof, or other suitable network, etc.) that is part of the network 112, or separate there from.

By way of example, the exemplary computing device 200 may include one or more servers, personal computers, laptops, tablets, PDAs, telephones (e.g., cellular phones, smartphones, other phones, etc.), terminals configured to process identification devices (e.g., point of sale (POS) terminals, etc.), combinations thereof, etc. as appropriate.

As shown in FIG. 2, the illustrated computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, one or more operating engines, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may be configured to store, without limitation, purchase data, transaction data, consumer profile data, metric profile data, and/or other types of data suitable for use as described herein, etc. In addition, the memory 204 may include one or more computer-readable media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, tapes, flash drives, hard disks, and/or any other type of volatile or nonvolatile physical or tangible computer-readable media. Further, computer-readable media may, in some embodiments, be selectively insertable to and/or removable from the computing device 200 to permit access to and/or execution by the processor 202 (although this is not required).

In various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a network interface 206 coupled to the processor 202 and the memory 204. The network interface 206 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

In some exemplary embodiments, the computing device 200 may also include an output device and/or an input device coupled to the processor 202.

The output device, when present in the computing device 200, outputs information and/or data to a user by, for example, displaying, audibilizing, and/or otherwise outputting the information and/or data. In some embodiments, the output device may comprise a display device such that various interfaces (e.g., webpages, etc.) may be displayed at computing device 200, and in particular at the display device, to display such information and/or data, etc. And in some examples, the computing device 200 may also (or alternatively) cause the interfaces to be displayed at a display device of another computing device, including, for example, a server hosting a website having multiple webpages, etc. With that said, the output device may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device may include multiple devices.

The input device, when present in the computing device 200, is configured to receive input from a user. The input device may include, without limitation, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both an output device and an input device.

Referring again to FIG. 1, in the illustrated system 100, the consumers 106-110 transact with the merchant 102, as desired, to purchase products (and/or services) from the merchant 102.

In some of the transactions, the consumers 106-110 provide payment account information to the merchant 102 to purchase the products (e.g., payment account numbers via credit cards, debit cards, pre-paid cards, etc.). For each of these transactions, the merchant 102 reads the payment account information and communicates, via the network 112, an authorization request to a payment network (via an acquirer associated with the merchant 102) to process the transaction (e.g., using the MasterCard® interchange, etc.). The payment network, in turn, communicates the authorization request to an issuer associated with the appropriate payment account. The issuer then provides an authorization response (e.g., authorizing or declining the request) to the payment network, which is provided back through the acquirer to the merchant 102. The particular transaction is then completed, or not, by the merchant 102, depending on the authorization response.

In other ones of the transactions, the consumers 106-110 provide cash or other non-account based payments to the merchant 102 to purchase the products. In still other transactions, the consumers 106-110 provide account based payment associated with different payment networks. In some aspects, the consumers 106-110 may also provide identification data, for example, for membership in merchant-based loyalty or reward programs, or otherwise, etc. (e.g., consumer names, consumer mailing addresses, merchant account numbers, etc.) to the merchant 102 with the payments, so that the consumers 106-110 can be subsequently identified, contacted, etc.

For each of these transactions, purchase data (e.g., longitudinal purchase data, etc.) is generated and stored by the merchant 102, for example, in memory 204 of the merchant's computing device 200, etc. The purchase data may include, without limitation, consumer identification data (e.g., a consumer name, a consumer mailing address, a consumer phone number, a consumer email address, merchant account numbers, etc.), a payment type or payment method used to purchase the products (e.g., credit card, debit card, pre-paid card, cash, check, etc.), a total payment amount for the purchased products, an identification of the purchased products, a date and/or time of the transaction for the purchased products, etc. For the transactions involving the consumer payment account information, the purchase data generated by the merchant 102 may overlap with (and may at least partially include) transaction data used (via the payment network) to authorize, clear, etc. the transactions. In addition, the transaction data may further (or alternatively) include, without limitation, payment account numbers for the consumer payment accounts, a merchant name for the merchant 102, a merchant identification number (MID) for the merchant 102, a merchant category code (MCC), etc.

In some exemplary embodiments, the consumers 106-110 may also be associated with non-payment accounts provided by or offered by the merchant 102 to encourage the consumers 106-110 to purchase products and/or services from the merchant 102 (e.g., reward accounts/cards, loyalty accounts/cards, etc.). These non-payment merchant accounts can be a part of the consumer identification and be used to longitudinally track purchases of (e.g., products purchased by, etc.) each of the consumers 106-110 at the merchant 102, and subsequently identify the consumers 106-110 and match the purchases to the consumers 106-110 (particularly where cash and pre-paid cards are used as the payment types). In addition, the purchase data generated for the consumer transactions in these embodiments may further include any additional data provided by the consumers 106-110 to the merchant 102 when the merchant accounts are created in relation to the corresponding reward/loyalty program, etc. (e.g., consumer age, consumer gender, other demographic data, etc.).

In various exemplary embodiments, the consumers 106-110 also agree to legal terms associated with the various accounts described herein, for example, during enrollment in the accounts, etc. In so doing, the consumers 106-110 may agree, for example, to allow the merchant 102, the issuers of the accounts, one or more payment networks to use consumer data in connection with processing transactions for one or more of the different purposes described herein (e.g., for use in evaluating the consumers 106-110 for lending products, etc.).

Separately, when desired to evaluate the consumers 106-110 for lending products, the consumer profile service 104 collects the purchase data for the consumers 106-110 from the merchant 102, via the network 112, and stores the data in data structure 114. In FIG. 1, the data structure 114 is illustrated as separate from the consumer profile service 104. However, it should be appreciated that the data structure 114 may be included in the memory 204 of the consumer profile service computing device 200 in various implementations. In addition, it should be appreciated that the purchase data can be stored in the data structure 114 in any desired manner so that it is readily usable as described herein (e.g., the purchase data can be stored in association with the consumers, in association with the merchant 102, in association with both the consumers and the merchant 102, etc.).

Once collected, the consumer profile service 104 uses the purchase data to compile profiles of the consumers 106-110 (e.g., profiles of all of the consumers 106-110, profiles of select ones of the consumers 106-110 (e.g., target consumers), etc.), which generally indicate purchasing behaviors, etc. of the consumers 106-110. The profiles are then compared with a metric profile to determine whether or not to qualify the consumers 106-110 to lending products (e.g., to determine whether or not the consumers 106-110 have sufficiently similar purchasing behaviors, etc. to those indicated in the metric profile to justifying providing lending products to the consumers 106-110; etc.). The qualified ones of the consumers 106-110 are then designated in the data structure 114 (e.g., the ones of the consumers 106-110 that have at least one consistency between their purchase data and the purchase data associated with the metric profile, etc.). And, product offers for appropriate lending products (e.g., lending products associated with the metric profile, etc.) are transmitted, by the consumer profile service 104, to them. Or, the consumers are identified to a lending entity (e.g., an issuer, etc.) offering the lending products, who then transmits the offers. This may be done in combination with, or apart from, credit record evaluations of the consumers.

The metric profile is based on purchase data for one or more consumers identified, for example, by the consumer profile service 104, as using a credit payment type for multiple ones of their transactions with the merchant 102. In the illustrated embodiment, the metric profile is compiled by the consumer profile service 104 from the purchase data received from the merchant 102. In particular, the metric profile includes a profile of one of the consumers identified by the consumer profile service 104 as using a credit payment type for multiple ones of their transactions with the merchant (e.g., a banked consumer such as consumer 106 in FIG. 1, etc.). The banked consumer 106 is a consumer who purchases products using a lending product, such as for example, a credit card. If the profiles of other ones of the consumers in the system 100 (e.g., consumers 108, 110, etc.) are similar to (or share at least one consistency with) the profile of the banked consumer 106, i.e., the metric profile (e.g., such that their purchasing behaviors, etc. are similar to those of the banked consumer 106, etc.), those consumers can be qualified to similar lending products currently associated with and/or currently available to the banked consumer 106 (e.g., in lieu of separate credit evaluations for the consumers 108, 110, etc.). In other words, the similarities in purchasing behavior (e.g., purchase frequency, total ticket size/value, basket/product details, etc.) between the various consumers 108, 110 with the banked consumer 106 can provide insight as to credit worthiness for the various consumers 108, 110 and, in some aspects, an indication of how much credit can be made available to the consumers.

In some embodiments, multiple different metric profiles may be used by the consumer profile service 104, with each of the metric profiles associated with a different lending product (e.g., as compiled by the consumer profile service 104 from the purchase data of multiple different consumers identified as using credit payment types for multiple ones of their transactions with the merchant, etc.). Here, the consumers 106-110 are then qualified by the consumer profile service 104, if appropriate, to the particular lending products associated with the metric profile that most closely matches their respective profile.

In addition, in some embodiments, after collecting the purchase data from the merchant 102 and identifying payment types from the purchase data for each of the transactions (e.g., credit card, debit card, pre-paid card, cash, etc.), the consumer profile service 104 may select particular target consumers estimated as having little or no access to current lending products (e.g., unbanked consumers, underbanked consumers, etc.). The profiles for these target consumers are then compared with the metric profile to determine whether or not to qualify the consumers to lending products. The target consumers may thus be qualified for lending products based on this correlation; alone or in combination with credit report evaluation. In some aspects, the metric profile (e.g., the consumer on which the metric profile is based, etc.) may be specifically based on, or selected based on, one or more relationships to the target consumers (e.g., age, gender, location, etc.) to help improve accuracy of the evaluation.

With that said, while three consumers 106-110 are illustrated in FIG. 1, it should be appreciated that the system 100 can accommodate multiple additional consumers in connection with transactions at the merchant 102 and with providing lending products to select ones of the multiple consumers. Further, while only one merchant 102 is illustrated in FIG. 1, it should be appreciated that the system 100 can accommodate multiple merchants (e.g., first merchants, second merchants, third merchants, etc.), and their interactions with the consumers 106-110. Purchase data may then be filtered, as desired, to particular ones of the merchants, to particular ones of the merchant locations, etc. to help improve accuracy of the evaluations. As such, when desired to evaluate the consumers 106-110 for lending products, the consumer profile service 104 may collect purchase data for not only the consumers 106-110 at the merchant 102, but also for the multiple additional consumers from each of the different merchants (and their various different merchant locations). And, analysis of the collected purchase data, for each of the consumers at each of the merchants, can then be performed as described herein (e.g., on a merchant by merchant basis, on a related merchant basis, on other bases, etc.). As such, in various aspects, this relates to loyalty/reward programs that span multiple different merchants.

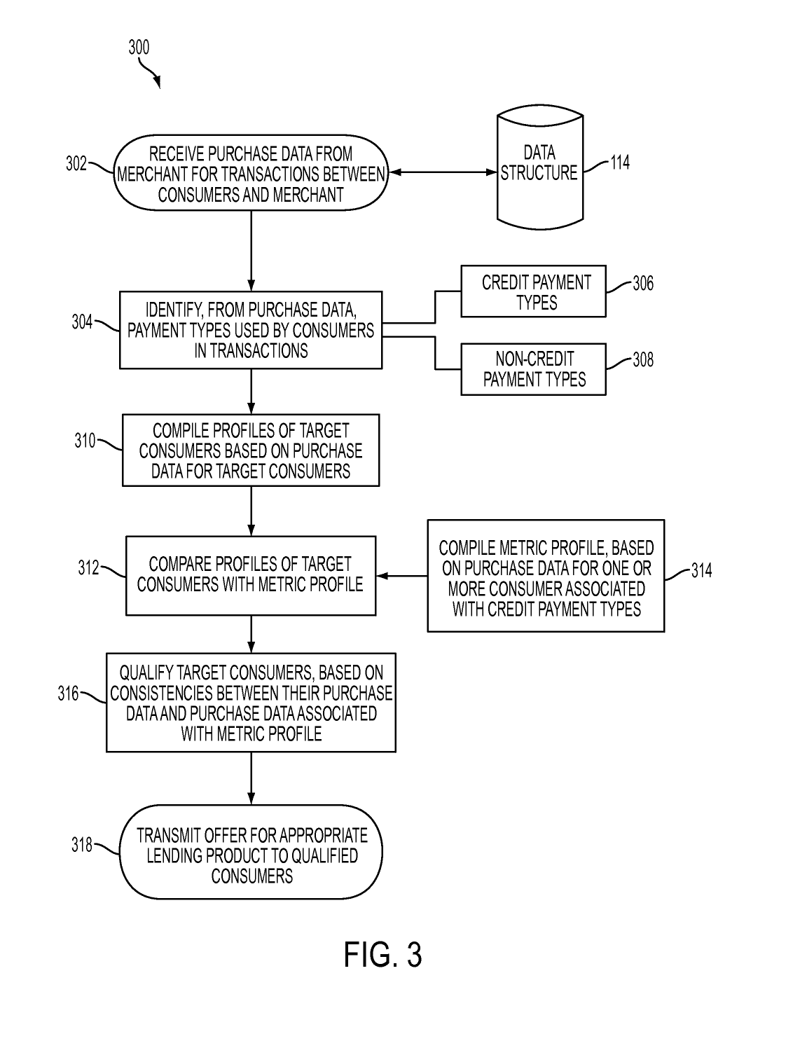

FIG. 3 illustrates an exemplary method 300 for providing a lending product to a consumer, whose credit record is limited or nonexistent (e.g., an unbanked consumer, an underbanked consumer, etc.), based on purchasing behaviors of the consumer (and in lieu of, or in combination with, credit reporting). In so doing, the consumer may be qualified for a lending product.

The exemplary method 300 is described as implemented in the consumer profile service 104 of the system 100 (e.g., in the computing device 200 of the consumer profile service 104, etc.), with further reference to the merchant 102 and the consumers 106-110. As previously stated, in the illustrated embodiment, the consumer profile service 104 is separate from other entities in the system 100. However, as previously stated, in at least some embodiments, the consumer profile service 104 may be included with the merchant 102, and/or with other entities not shown in FIG. 1 (e.g., a payment network configured to facilitate payment transactions in the system 100, an issuer of payment accounts to the consumers 106-110 in the system 100, etc.). In addition, for purposes of illustration, the exemplary method 300 is described herein with reference to the computing device 200. However, the methods herein should not be understood to be limited to the exemplary system 100 or the exemplary computing device 200. Similarly, the systems and the computing devices herein should not be understood to be limited to the exemplary method 300.

As described for the system 100, purchase data is generated and collected by the merchant 102 in connection with each of the multiple transactions by the consumers 106-110 to purchase products (and/or services) from the merchant 102. The merchant 102 collects this data for multiple longitudinal strings of the transactions for each of the consumers 106-110, and stores it in the memory 204 of the merchant computing device 200. To help facilitate collection of this data, the merchant 102 tracks the transactions through the non-payment merchant accounts provided to the consumers 106-110 (e.g., reward accounts/cards, loyalty accounts/cards, etc.), or through other means. In the illustrated method, for each of the transactions, the purchase data includes an identification of the of the particular consumer 106-110 making the transactions (e.g., from the non-payment merchant account associated with the consumer, etc.), a payment type or payment method used to purchase the products from the merchant 102, a total payment amount for the purchased products, a listing of the products purchased in the transaction, and a date and time of the transaction for the purchased products.

With reference now to FIG. 3, when desired to evaluate the consumers 106-110 for lending products, the consumer profile service 104 receives, via the processor 202, the collected purchase data from the merchant 102, at 302, for each of the transactions in which products were purchased by the consumers 106-110 from the merchant 102. The purchase data is then stored in the data structure 114, as desired, for subsequent access as described herein. Communication of the purchase data from the merchant 102 to the consumer profile service 104 may be done in response to a request by the consumer profile service 104 for the data, for example, in order to identify one or more of the consumers 106-110 for evaluation for the lending product. Or, it may be done in response to a request by the merchant 102 or by another entity (e.g., an issuer of lending products, etc.), for similar reasons.

In the illustrated method 300, the purchase data received by the consumer profile service 104, from the merchant 102, includes all purchase data collected by the merchant 102 that satisfies one or more predefined criteria set by the consumer profile service 104 (which may or may not be based on the particular lending decision to be made, etc.). For example, the consumer profile service 104 may request, and receive, all available purchase data for the consumers 106-110 at the merchant 102, purchase data relating to purchases by the consumers 106-110 at the merchant 102 over a particular time interval (e.g., a one day time interval, a one week time interval, a two week time interval, a one month time interval, a two month time interval, etc.), or purchase data for select ones of the consumers 106-110, etc.

Next, at 304, the consumer profile service 104 identifies (from the purchase data), via the processor 202 (e.g., via a correlation engine associated with the processor 202, etc.), a payment type used by each of the consumers 106-110 in each of their transactions with the merchant 102. In the illustrated method, the payment types include credit payment types 306 and non-credit payment types 308; however, other payment types may be used/identified within the scope of the present disclosure. Generally, credit payment types are associated with consumers that use credit cards to purchase products (e.g., banked consumers that have access to lending products, etc.), and non-credit payment types are associated with consumers that use cash, pre-paid cards, etc. to purchase products (e.g., unbanked consumers and underbanked consumers that have little or no access to lending products, etc.). With that in mind, in the illustrated method 300, the consumer profile service 104 identifies that the consumer 106 used credit cards in multiple ones (e.g., greater than two, etc.) of his/her transactions with the merchant 102, and classifies the consumer 106 as banked. The consumer profile service 104 identifies from the received purchase data that the consumer 108 used only cash in all of his/her transactions with the merchant 102, and classifies the consumer 108 as unbanked/underbanked. And, the consumer profile service 104 identifies that the consumer 110 used combinations of cash and pre-paid cards in all of his/her transactions with the merchant 102, and classifies the consumer 110 as unbanked/underbanked.

With continued reference to FIG. 3, in the illustrated method 300, after identifying the payment types used in the transactions at 304, the consumer profile service 104, via the processor 202 (e.g., again via the correlation engine, etc.), compiles a profile of the unbanked/underbanked consumer 108 and compiles a profile of the unbanked/underbanked consumer 110 (e.g., the target consumers), at 310, based on their corresponding purchase data at the merchant 102. Each profile includes an identification (e.g., a listing, etc.) of the products purchased by the respective consumer 108, 110 at the merchant 102, in each particular transaction with the merchant 102 (such that all of the products purchased by the respective consumer 108, 110 in a given transaction are grouped together), and a payment amount for the purchased products in each transaction (e.g., a payment amount for each individual product purchased in the transaction, a total payment amount for all products purchased in the transaction, etc.).

At 312, the consumer profile service 104, via the processor 202 (e.g., again via the correlation engine, etc.), next compares the profile of the unbanked/underbanked consumer 108 and the profile of the unbanked/underbanked consumer 110 to the metric profile. In the illustrated method 300, the metric profile is compiled, at 314, by the consumer profile service 104, based on purchase data for products purchased by the banked consumer 106 at the merchant 102 (in similar fashion to compilation of the profiles for the consumers 108, 110). As with the profiles for the consumers 108, 110, the metric profile includes an identification of the products purchased by the banked consumer 106 at the merchant 102, in each particular transaction with the merchant 102, and a payment amount for the purchased products in each transaction. As previously described, in other embodiments, the metric profile may be based on purchase data from one or more other consumers identified as using credit payment types at the merchant 102 (or, in some of these embodiments, at merchants related to merchant 102, etc.).

As can be seen, by analyzing the basket level information for the various consumers 106-110, “look-a-like” models can be built for each of the consumers 106-110 for use in comparing purchasing behaviors of various consumers to a metric profile for determining whether or not to qualify the consumers to lending products. With that said, in comparing the profiles of the unbanked/underbanked consumers 108, 110 with the metric profile in the illustrated method (e.g., comparing the purchase data of the consumers 108, 110 to the purchase data of the banked consumer 106, etc.), the groups of products in each of the unbanked/underbanked consumer transactions are compared to the groups of products in each transaction of the metric profile (i.e., in each transaction performed by the banked consumer 106). This analysis determines if the profile of the banked segment, as represented by the metric profile, matches the purchasing behavior of the unbanked/underbanked consumers 108, 110. In particular, the product groups are analyzed for one or more similar product types, similar transaction amounts (e.g., at a product level, at a total transaction level, etc.), etc. When one or more of these similarities is found (or when they share at least one consistency), the consumer profile service 104 flags the profile (and the corresponding unbanked/underbanked consumer 108 and/or 110) as being related to the metric profile (and the banked consumer 106). Without limitation, similarities (or consistencies) between the product groups in the profiles may include, for example, at least one matching product (e.g., the same product, products in similar categories of goods, etc.) in at least one group of the compared transactions, multiple matching products in at least one group of the compared transactions, at least one matching product in multiple groups of the compared transactions, multiple matching products in multiple groups of the compared transactions, at least one matching transaction amount (e.g., within acceptable tolerances of purchase frequency (e.g., within one day, two days, one week, one month, etc.), total ticket size (e.g., +/−two dollars, +/−five dollars, etc.), consumption habits that include brand preferences, category breakdowns (e.g., fresh groceries, frozen foods, etc.), etc.), multiple matching transaction amounts, etc.

Credit records are available for the banked consumer 106, whose purchase data is used in the method 300 as the basis for the metric profile. As such, when the comparison between the profiles of the unbanked/underbanked consumers 108, 110 and the metric profile suggests that a relation exists, it provides an indication that the consumers 108, 110 likely have purchasing behaviors similar to those of the banked consumer 106. Based on these similarities (and in lieu of, or in addition to, requiring credit data), the consumer profile service 104 qualifies (e.g., designates a qualification to, etc.) the consumers 108, 110, at 316, via the processor 202 (e.g., via a reporting engine associated with the processor 202, etc.) to appropriate lending products (e.g., lending products in line with those currently associated with and/or available to the banked consumer 106, other appropriate lending products, etc.). The qualifications are then stored in the data structure 114 in connection with the consumers 108, 110. And, the consumer profile service 104, via the processor 202 (e.g., again via the reporting engine, etc.), transmits, at 318, product offers to the consumers for the appropriate lending products.

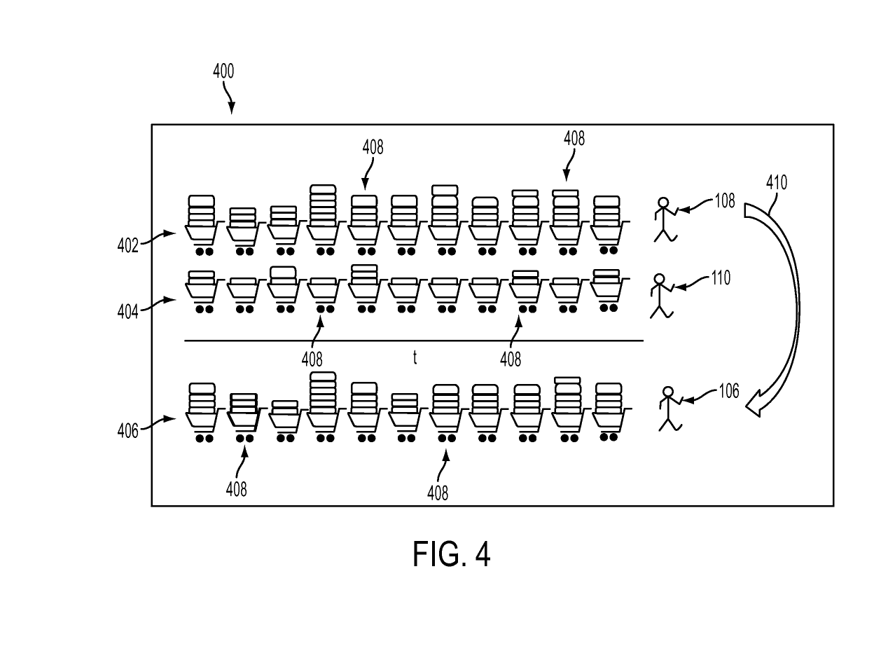

FIG. 4 provides a model 400 illustrating example profiles 402-406 of the unbanked/underbanked and banked consumers 106-110 compiled in connection with the method 300 of FIG. 3. In each of the profiles 402-406, the products purchased by the consumers from the merchant 102, for each of the transactions with the merchant 102 over time interval t, are arranged in groups 408 (or baskets), with each of the groups 408 representing a different transaction between the corresponding consumers 106-110 and the merchant 102. In addition, in each of the groups 408, the products are coded to generally indicate their type (e.g., groceries (and/or specific types of groceries such as meat, dairy, etc.), clothing, etc.), and are sized to generally indicate payment amounts for the products. With that said, it should be appreciated that such profiles may be illustrated differently (e.g., the profiles may be numerically illustrated, etc.) and/or may include other or different purchase data (or other data all together) than shown in FIG. 4 within the scope of the present disclosure.

As can be seen in the FIG. 4, the profile 402 of the unbanked/underbanked consumer 108 and the profile 406 of the banked consumer 106 (i.e., the metric profile) have several matching groups 408 of products (as indicated by arrow 410), thus suggesting a relation in purchasing behavior between the consumer 108 and the banked consumer 106. In contrast, the profile 404 of the unbanked/underbanked consumer 110 and the metric profile 406 lack any matching groups, suggesting no relation therebetween. Since credit records are available for the banked consumer 106, the consumer profile service 104 can qualify the consumer 108, in this example, to one or more appropriate lending products based on his/her purchasing relationships to the banked consumer 106 (and in lieu of needing unavailable or think credit records for the consumer 108). The one or more appropriate lending products may be in line with lending products currently associated with the banked consumer 106 or currently available to the banked consumer 106, or they may include other appropriate lending products.

In some exemplary embodiments, consumers participate in one or more enrollment processes in connection with one or more of the features described herein. In the enrollment process, the consumers agree to participate. In doing so, consumers agree to legal terms with the payment networks, account issuers, merchants, or other program sponsors, etc., which permit certain uses of the consumer data, including as described herein. This may involve a unified process or multiple separate processes with the various entities associated with the use of consumer data, including the payment networks, issuers, merchants, or other program sponsors, etc. The consumers may agree to allow the program operator to monitor their payment account and/or transaction data for purposes of assessing credit worthiness, for example.

Enrollment may be completed in a number of ways, for example, in person or remotely via interfaces provided through applications and/or websites of the issuers, payment networks, acquirers, merchants, etc. In addition, in various implementations, some levels of consumer data will not be utilized even when the consumers elect to participate (e.g., health care related data, etc.). Use of consumer data in all cases is consistent with current law and policy. More generally, there is preferably no analysis, at certain levels, without the consumer's consent, and further some data may not be appropriate for analysis even with the consumer's consent.

Within the methods and systems herein, appropriate usage limits are preferably placed on use of consumer data. For example, appropriate age limits are preferably enforced on those enrolling and, of course, all applicable laws, rules, regulations, policies and procedures with respect to age of consumers, privacy, and the like should always be fully complied with.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving purchase data from transactions at a merchant by first and second consumers, the purchase data associated with non-payment accounts of the first and second consumers, the purchase data indicating a credit payment type for multiple ones of the transactions by the second consumer; (b) identifying, from the purchase data, a payment method for the products purchased from the merchant by the first and second consumers; compiling profiles of the consumers based on the purchase data; (c) comparing the purchase data for the first consumer and the purchase data for the second consumer, or comparing the profiles of the consumes to a metric profile; (d) designating a qualification to the first consumer based on at least one consistency between the purchase data for the first consumer and the purchase data for the second consumer, where the qualification is associated with at least one lending product; (e) storing the qualification in memory; and (f) one or more of transmitting a product offer to the first consumer for the at least one lending product and identifying the first consumer to a lending entity offering the at least one lending product.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” or “associated with” another feature, element or layer, it may be directly on, engaged, connected, coupled, or associated with/to the other feature, element or layer, or intervening features, elements or layers may be present. In contrast, when feature, element or layer is referred to as being “directly on,” “directly engaged to,” “directly connected to,” “directly coupled to,” “directly associated with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of providing lending products to consumers based on purchasing behaviors of the consumers, the method comprising:
receiving, at a computing device, purchase data from transactions at a merchant by first and second consumers, the purchase data associated with non-payment accounts of the first and second consumers, the purchase data indicating a credit payment type for multiple ones of the transactions by the second consumer;
comparing, at the computing device, the purchase data for the first consumer and the purchase data for the second consumer;
designating a qualification to the first consumer based on at least one consistency between the purchase data for the first consumer and the purchase data for the second consumer, the qualification associated with at least one lending product; and
storing the qualification in memory associated with the computing device.

2. The method of claim 1, wherein the non-payment accounts are loyalty accounts associated with the merchant and/or reward accounts associated with the merchant.

3. The method of claim 2, wherein the transaction data indicates a non-credit payment type for substantially all of the transactions by the first consumer.

4. The method of claim 1, further comprising transmitting a product offer to the first consumer for the at least one lending product.

5. The method of claim 4, wherein the credit payment type of the second consumer is associated with at least one lending product; and
wherein the at least one lending product associated with the qualification designated to the first consumer corresponds to the at least one lending product associated with the second consumer.

6. The method of claim 1, wherein the received purchase data includes purchase data for products purchased from the merchant in each of the transactions by the first and second consumers over a common time interval.

7. The method of claim 6, wherein comparing the purchase data includes comparing the products included in the transactions by the first consumer to the products included in the transactions purchased by the second consumer; and
wherein designating the qualification to the first consumer includes designating the qualification to the first consumer when multiple ones of the products purchased by the first consumer match multiple ones of the products purchased by the second consumer.

8. The method of claim 1, further comprising identifying the first consumer to a lending entity offering the at least one lending product.

9. A computer-implemented method of providing lending products to consumers based on purchasing behaviors of the consumers, the method comprising:
receiving, at a computing device, purchase data associated with a non-payment account from a merchant, the purchase data representing transactions at the merchant by a first consumer, the purchase data indicating a non-credit payment type for substantially all of the transactions by the first consumer;
compiling, at the computing device, a profile of the first consumer based on the purchase data for the first consumer;
comparing, at the computing device, the profile of the first consumer and a metric profile; and
qualifying the first consumer for at least one lending product, based on at least one consistency between the profile of the first consumer and the metric profile.

10. The method of claim 9, further comprising:
receiving, at the computing device, purchase data representing transactions at the merchant by at least one second consumer, the purchase data associated with a non-payment account from the merchant and indicating a credit payment type for at least some of the transactions by the at least one second consumer; and
compiling, at the computing device, the metric profile based on the purchase data associated with the at least one second consumer.

11. The method of claim 10, wherein the credit payment type of the at least one second consumer is associated with at least one lending product; and
wherein the at least one lending product for which the first consumer is qualified is based on the at least one lending product associated with the at least one second consumer.

12. The method of claim 10, further comprising identifying the at least one second consumer based on at least one of the location, gender, and age of the first consumer.

13. The method of claim 10, further comprising identifying the qualified first consumer to a lending entity offering the at least one lending product.

14. The method of claim 10, wherein the merchant is a first merchant; and
further comprising:
receiving, at the computing device, purchase data associated with a non-payment account from a second merchant, the purchase data representing transactions at the second merchant by a third consumer, the purchase data indicating a non-credit payment type for substantially all of the transactions by the third consumer;
compiling, at the computing device, a profile of the third consumer based on the purchase data for the third consumer;
comparing, at the computing device, the profile of the third consumer and a metric profile associated with the second consumer; and
qualifying the third consumer for at least one lending product, based on at least one consistency between the profile of the third consumer and the metric profile.

15. The method of claim 14, further comprising:
receiving, at the computing device, purchase data representing transactions at the second merchant by at least one fourth consumer, the purchase data associated with a non-payment account from the second merchant and indicating a credit payment type for at least some of the transactions by the at least one fourth consumer; and
compiling, at the computing device, the metric profile associated with the second consumer based on the purchase data associated with the at least one fourth consumer.

16. The method of claim 9, wherein comparing the profile of the first consumer and the metric profile includes comparing products purchased by the first consumer to products identified in the metric profile; and
wherein qualifying the first consumer for the at least one lending product includes qualifying the first consumer when multiple ones of the products purchased by the first consumer match multiple ones of the identified products in the metric profile.

17. A system for use in providing lending products to consumers based on purchasing habits of the consumers, the system comprising:
a data structure comprising purchase data for products purchased by consumers in transactions at multiple different merchants, the purchase data associated with non-payment accounts provided by the merchants to the consumers;
a correlation engine comprising computer executable instructions that, when executed by at least one processor, cause the at least one processor to:
identify payment methods, from the purchase data in the data structure, for the transactions at the multiple different merchants,
compile profiles of the consumers based on the purchase data, each of the profiles associated with transactions by individual ones of the consumers at individual ones of the merchants; and
for at least one of the merchants, compare the profile of a target one of the consumers whose purchase data at the at least one of the merchants indicates a non-credit payment type with a metric profile based on at least one of the consumers whose purchase data at the at least one of the merchants includes a credit payment type; and
a reporting engine comprising computer executable instructions that, when executed by at least one processor, cause the at least one processor to designate a qualification to the target one of the consumers based on at least one consistency between the profile of the target one of the consumers and the metric profile, the qualification associated with at least one lending product.

18. The system of claim 17, wherein the reporting engine further comprises computer executable instructions that, when executed by the at least one processor, cause the at least one processor to transmit a product offer to the target one of the consumers, the product offer including an offer for the at least one lending product.

19. The system of claim 17, wherein the profile of the target one of the consumers includes an identification of products purchased by the target one of the consumers at the at least one of the merchants; and
wherein the metric profile includes an identification of products purchased by the at least one of the consumers whose purchase data at the at least one of the merchants includes a credit payment type.

20. The system of claim 19, wherein the comparison of the profile of the target one of the consumers with the metric profile includes a comparison of the products purchased by the target one of the consumer to the products purchased by the at least one of the consumers whose purchase data at the at least one of the merchants includes a credit payment type; and
wherein the qualification is designated to the target one of the consumers when multiple ones of the products purchased by the target one of the consumers matches multiple ones of the products purchased by the at least one of the consumers whose purchase data at the at least one of the merchants includes a credit payment type.
